(19) United States
(12) Patent Application Publication
(10) Pub. No.: US 2011/0228913 A1
(43) Pub. Date: Sep. 22, 2011

(54) AUTOMATIC EXTRACTION OF INFORMATION FROM ONGOING VOICE COMMUNICATION SYSTEM AND METHODS

(75) Inventors: Munir Cochinwala, Basking Ridge, NJ (US); Adam Drobot, Bernardsville, NJ (US); Ashish Jain, Bridgewater, NJ (US); John R. Wullert, II, Martinsville, NJ (US)

(73) Assignee: TELCORDIA TECHNOLOGIES, INC., Piscataway, NJ (US)

(21) Appl. No.: 12/724,611

(22) Filed: Mar. 16, 2010

(51) Int. Cl. H04M 1/64

(52) U.S. Cl. 379/85

(57) ABSTRACT

A system and methods are provided for automatically extracting information from ongoing voice communications. A signal is received at an electronic processor indicating that a portion of an ongoing communication is to be recorded. As a result of that signal, the ongoing communication is recorded and then analyzed to identify information suitable for storage in an address directory of a participant to the communication maintained in an electronic storage medium. Thereafter, the extracted information is sent to that address directory for storage there. In the alternative, when the extracted information is a telephone number, a call based upon that number may be placed automatically and connected into the ongoing communication.

### BACKGROUND

1. Technical Field

The system and methods disclosed herein relate to the field of directory management and, more specifically, to a system and methods that permit automatic extraction of information from ongoing voice communications and insertion of that information into appropriate electronic directories.

2. Description of the Related Art

During a telephone conversation, a person will often communicate information that the other party needs to record for future reference. Two specific examples are telephone numbers and e-mail addresses. While the advent of caller ID has reduced the need for a person to provide the called party with the number from which he is calling, there are many cases where a person may wish to communicate other numbers where he can be reached.

For example, a person may be going on vacation or otherwise traveling, and he may wish to communicate a number at which he can be reached during that time frame. A person may wish to provide a telephone number for a house that he is currently renting or a different number at a different location. Another example includes providing an e-mail address, which allows a person to send a message or attach documents. A person may also be providing the number or address of a third party, who is not a participant in the current conversation session.

Recipients of this data face the issue of transcribing this information in order to make use of it. This transcription can take many forms. It may take the form of remembering a phone number and dialing it immediately upon disconnecting the current call. It might involve scribbling an e-mail address on a piece of paper, which may later be entered into the “to” field of an e-mail message, or it may take the form of entering a name and street address into the user's computer or smart phone as part of an address book entry.

In many of these cases, the initial transcription can be hindered if the user is involved in another activity, such as driving a vehicle, or if he has no means to record the information because he lacks immediate access to a writing instrument or paper. In addition, users often end up transcribing such information twice: first, when the information is written in a manner that can most quickly be recorded and is fresh in the user's mind, and then subsequently when the information is entered into an electronic address directory. This two-stage process increases the likelihood of transcription errors.

Given this situation, there is a need for a system and related methods that would directly transcribe contact address information from voice communications into an electronic directory.

### SUMMARY

In one embodiment, a method is provided for automatic extraction of information from ongoing voice communications. This method includes the steps of receiving at an electronic processor a signal indicating that a portion of an ongoing communication is to be recorded. This method further includes the step of recording that portion of the ongoing communication in response to that signal and analyzing that portion of the recorded communication to identify information suitable for storage in an address directory of a participant of the communication maintained in an electronic storage medium. Thereafter, the method includes the step of sending that identified information to that address directory for storage.

Preferably, a participant in the communication has the capacity to selectively generate a signal, which indicates that a portion of the ongoing communication is to be recorded. Thus, the step of generating that signal may be implemented by manual intervention of a participant in the communication. In the alternative, an automatic determination may be undertaken that information suitable for storage in an address directory is likely to follow in the communication.

The recording step may last for a predetermined time period, or it may last until the processor is instructed by a participant of the communication to stop recording, The recording step may also last until there is detection of information suitable for storage in an address directory, until a pause in the ongoing communication is detected after detection of information suitable for storage in an address directory, until a pause in the ongoing communication is detected, or until there is the detection of a change in speaker in the ongoing communication.

The step of analyzing may include identifying likely telephone numbers, likely e-mail addresses, or likely first and last name combinations. The step of analyzing may, in addition, also include interactive communications with one or more participants in the ongoing communication to assure that the proper information has been identified for inclusion in a directory. The step of analyzing may be undertaken in real time during the ongoing communication or it may be conducted after termination of the ongoing communication.

The identified information preferably is stored in an electronic directory and is used to update that directory. It is also possible to store the entire recorded portion in the directory so as to allow the recorded portion to be accessible in order to confirm that the information updated in the directory is in fact accurate.

Consistent with another embodiment, a method for automatic extraction of information from ongoing voice communications is provided comprising the steps of: receiving at an electronic processor a signal indicating that a portion of an ongoing communication is to be recorded; recording that portion of the ongoing communication in response to that signal; analyzing that portion of the recorded communication to identify a telephone number; causing that telephone number to be called; and causing the resultant call to be coupled into the ongoing communication. In this embodiment, the identified telephone number may also be utilized to update a directory of one or more of the communication participants.

The present invention may also take the form of a system for automatic extraction of information from ongoing voice communications, the system comprising an electronic processor connected to a communication system. The electronic processor is programmed to recognize a signal indicating that a portion of an ongoing communication is to be recorded; record that portion of the ongoing communication in response to that signal; analyze that portion of the recorded communication to identify information suitable for storage in an address directory of a participant of the communication maintained in electronic storage medium; and send the identified information to that directory.

Still further, the invention may take the form of a computer-readable storage medium that, when executed in a system, causes the system to perform a method of automatic extraction of information from ongoing voice communications, the method comprising the steps of: receiving at an electronic processor a signal indicating that a portion of an ongoing communication is to be recorded; recording that portion of the ongoing communication in response to that signal; analyzing that portion of the recorded communication to identify information suitable for storage in an address directory of a participant of the communication maintained in electronic storage medium; and sending that identified information to the directory for storage therein.

It is important to understand that both the foregoing general description and the following detailed description are exemplary and explanatory only, and are not restrictive of the invention as claimed.

### BRIEF DESCRIPTION OF THE DRAWINGS

The accompanying drawings, which are incorporated in and constitute a part of this specification, illustrate various embodiments. In the drawings:

FIG. 1 is a functional diagram of one example of an automated directory update system utilizing principles of the present invention.

FIG. 2 is a functional diagram of one example of an automated directory update system with an interactive voice response function for collecting user input utilizing principles of the present invention.

FIG. 3 illustrates several options for collecting audio information in a voice/DTMF monitoring function utilizing principles of the present invention.

FIG. 4 illustrates an example of updating a directory using a public switched telephone network (PSTN) while utilizing principles of the present invention.

### DESCRIPTION OF THE EMBODIMENTS

In the following description, for purposes of explanation and not limitation, specific techniques and embodiments are set forth, such as particular sequences of steps, interfaces, and configurations, in order to provide a thorough understanding of the techniques presented here. While the techniques and embodiments will primarily be described in the context of the accompanying drawings, those skilled in the art will further appreciate that the techniques and embodiments can also be practiced in other electronic devices or systems.

Reference will now be made in detail to exemplary embodiments of the present invention, examples of which are illustrated in the accompanying drawings. Whenever possible, similar reference numbers will be used throughout the drawings to refer to the same or like parts.

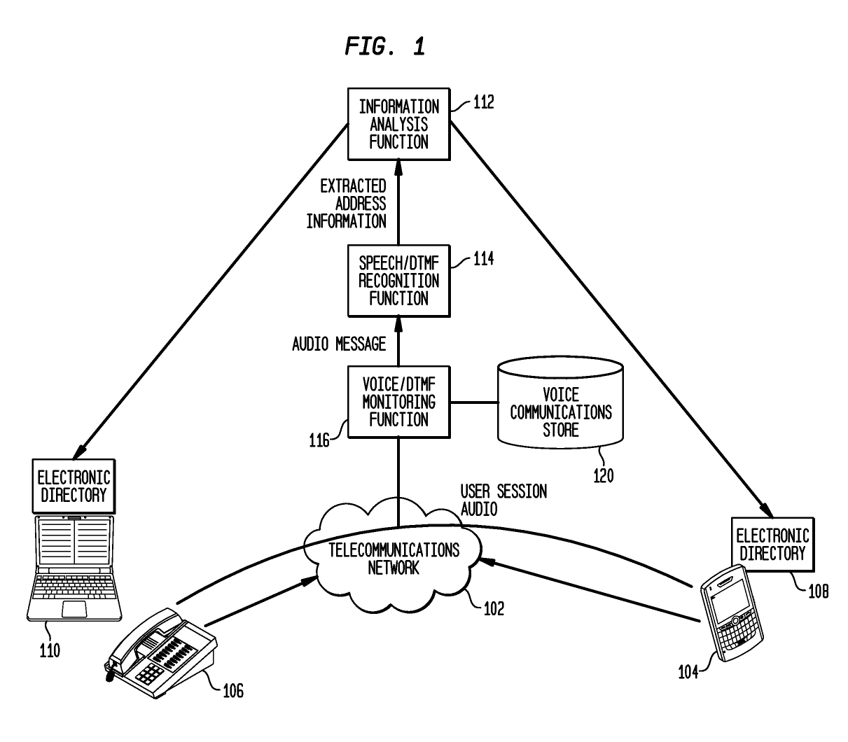

FIG. 1 illustrates one example of an automated directory update system utilizing principles of the present invention. As shown in FIG. 1, a telecommunications network 102 provides a voice channel communication between two electronic devices, which are illustrated in FIG. 1 as smart phone 104 and conventional telephone 106. Smart phone 104 has an internal electronic directory 108 and telephone 106 has associated with it an external electronic directory 110 that is physically located in the memory of a personal computer or is accessible by server or other like means.

This system of FIG. 1 further includes an information analysis function 112, a speech/DTMF recognition function 114, and a voice/DTMF monitoring function 116 with an associated voice communications store 120.

Thus, as shown in FIG. 1, calls may be made between two or more terminal devices, illustrated in FIG. 1 as smart phone 104 and telephone 106, be they landline telephones, cell phones, computers, or the like. Each is connected by telecommunications network 102 to a voice/DTMF monitoring function 116. Voice/DTMF monitoring function 116 may reside in any form of electrical device connectable to telecommunications network 102.

When a participant to an ongoing voice communication utilizing telecommunications network 102 wishes to capture a portion of a session, that user signals a request to voice/DTMF monitoring function 116. This signaling might occur simply by having the user utter a phrase that is identifiable by voice/DTMF monitoring function 116 as a user request, such as “let me give you that number.”

The signal from the user to initiate voice/DTMF monitoring function 116 could be sent by in-band techniques, such as the user using a specific phrase. In addition to the example “let me give you that number,” such a phrase may be in the form of “voice monitor,” “record,” or the like. The key is that the phrase must be recognizable by voice/DTMF monitoring function 116 as indicating a desire to implement that function.

It is also possible that the user request signal may take the form of a sequence of numbers or symbols that has been punched out by the user on a keypad, such as “##,” generating dual-tone multi-frequency (DTMF) tones or the like. Out-of-band signaling may also be employed, such as clicking a link on smart phone 104 that sends a message to voice/DTMF monitoring function 116.

Upon receiving the request, voice/DTMF monitoring function 116 captures the subsequent conversation and passes the audio information of that conversation to a speech/DTMF recognition function 114. In capturing the audio, voice/DTMF monitoring function 116 might record a subsequent portion of the communication (or perhaps hold a portion that was being recorded at the time the request was received), holding it in a voice communications store 120, and then passing the stored portion to speech/DTMF recognition function 114 as a file, as opposed to simply feeding the audio stream directly to speech/DTMF recognition function 114.

Voice/DTMF monitoring function 116 must determine how long to record the audio or to feed the audio stream to speech/DTMF recognition function 114. This timing may be determined, for example, by a second signal from the requesting user, indicating that the recording and streaming should stop. In the alternative, the recording could continue until the call is ended, until there is silence, or until the first user to speak after the request was made finishes speaking.

Speech/DTMF recognition function 114 is configured to search the audio stream for phrases of specific types that represent addresses or other information useful for an electronic directory. These phrases could include the following as examples:
a string of digits of a preselected length;
prefix phrases such as “the number is . . . ” or “my e-mail address is . . . ”;
phrases that match the pattern of a verbally recited e-mail address (namely, phrases that include the word “AT” followed at some point shortly thereafter by the word “DOT,” and possibly looking for the notation “COM,” “EDU,” “NET,” “MIL,” or the like after the word “DOT”;
phrases that match the pattern of a recited postal address, such as a number string and shortly thereafter the word “ROAD,” “STREET,” or “AVENUE,” or the like, with the possible additional search for a city name, state name, or zip code thereafter; or
a first name-last name combination.

Speech/DTMF recognition function 114 extracts as many of these items as it can from the audio stream and feeds them to information analysis function 112. Information analysis function 112 then assembles the collected information into a directory entry. This directory entry may be sparse in that many of the fields could simply be empty, for example, a field containing a phone number with no other information, or a field containing an e-mail address and name but no postal address or phone number, or the like. Note that the analysis function 112 could be integrated with the speech/DTMF recognition function. 114 For example, the speech/DTMF recognition function 114 could be configured to recognize certain spoken utterances (e.g., “My number is” followed by digits) and categorize the resulting text as being specific elements within a directory entry.

Information analysis function 112 then uses the partial directory entry as a query to the requesting party's electronic directories. Information analysis function 112 then determines if and how to update the electronic directories based on the response. This determination is based on a set of rules, which will potentially include multiple queries to the directories.

The present inventors have devised automated means of updating electronic directories by parsing voicemail messages, and the same techniques may be applied here with real-time voice communications. See, for example, the copending application entitled, “Automated Directory Updates from Voicemail,” Ser. No. ______, filed ______. The content of this application is hereby expressly incorporated by reference.

With multiple users involved in the call, information analysis function 112 preferably performs individual queries and corresponding updates for each of the participants in the call. In this way, a single person in a multiparty conference call could recite an address or the like, and that information could propagate to the electronic directories of all the individuals involved in the call.

Information analysis function 112 preferably also can interact with the user or users to determine how to handle the directory updates. This interaction could be initiated by information analysis function 112 in several ways. If the users have smart phones or computers, information analysis function 112 could send a message to them requesting user input. The interaction with the user could also be accomplished through a voice channel.

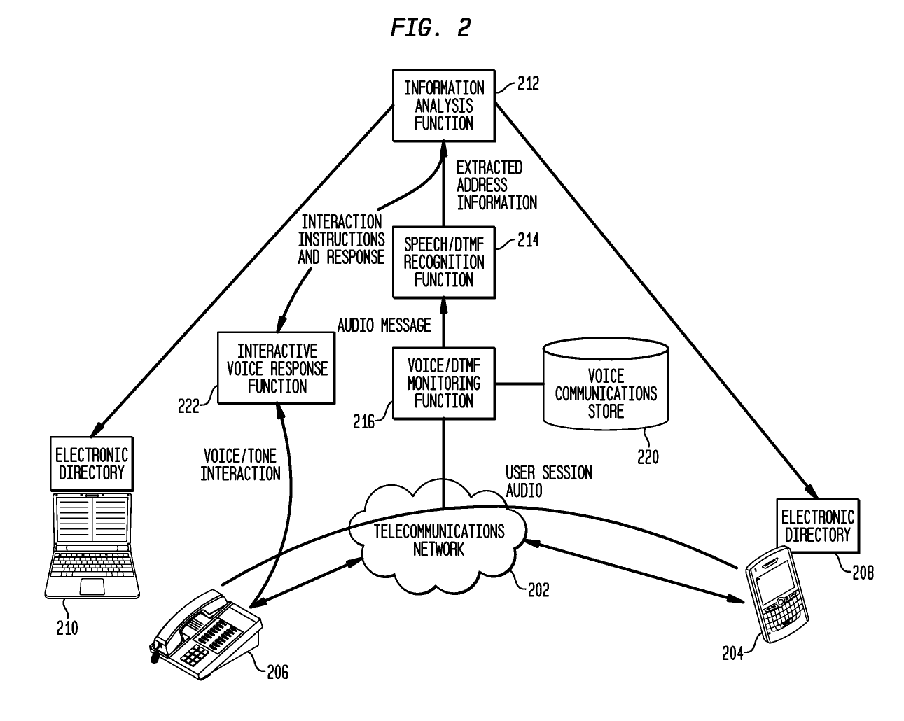

As shown in FIG. 2, in which items corresponding to those shown in FIG. 1 have corresponding numbers in the 200 range, information analysis function 212 triggers an interactive voice response function 222 that generates audio information to the user or users, requesting input on how to handle the directory update. This request may provide several different options to the user, such as allowing the user to fill in parts of a directory entry that are empty or asking the user for permission to update an existing entry when a match is found. The interaction could be launched immediately after the directory entry queries have been made or could wait until the end of the call. Alternatively, the interaction could be triggered by a user request, either by using a verbal parenthetical such as (“voice monitor-update directory”), a touchtone signal, or an out-of-band signal, such as clicking a link on a smart phone.

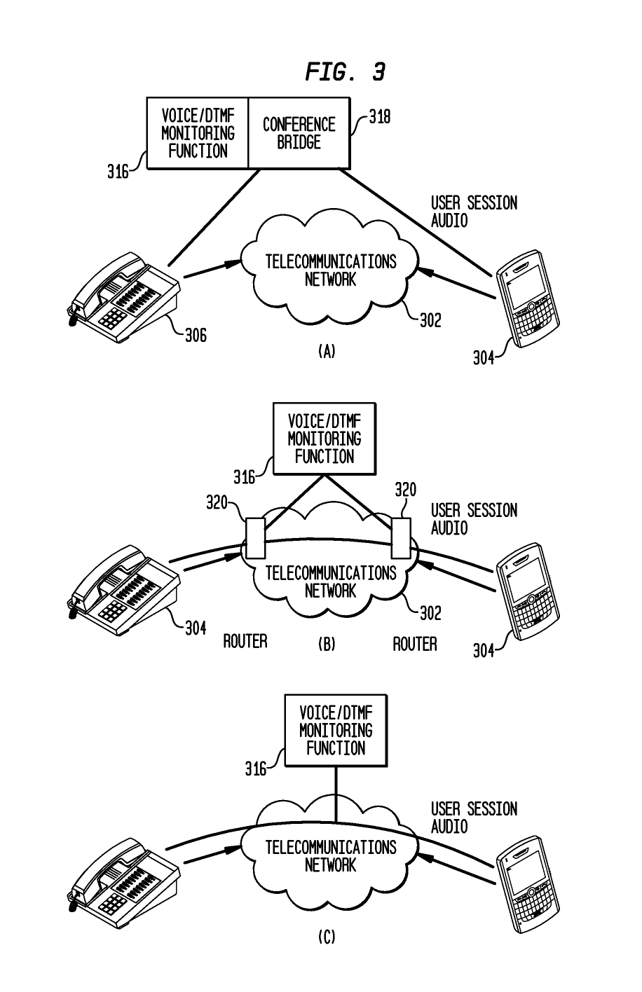

As shown in FIG. 3, where once again items corresponding to those shown in FIGS. 1 and 2 have similar numbers but are now in the 300 range, there are multiple ways in which the voice/DTMF monitoring function of the present invention could connect to the audio stream between the call participants. If the call is between participants in a multiparty conference call using a conference bridge, the voice/DTMF monitoring function could be built into or as an adjunct to conference bridge 318, as shown, for example, in FIG. 3(A).

Conference bridge 318 could also be used in the case of two-party calls to provide access to voice/DTMF monitoring function 316. Voice/DTMF monitoring function 316 could be built into, or serve as an adjunct to, conference bridge 318. The users would not have to be made aware that the call was being routed through conference bridge 318; they could simply dial in the normal fashion, but an application could intercept the request signal and reroute the call through conference bridge 318 to the called party.

As is shown in FIG. 3(B), in networks that support packet replication and forwarding, such as Internet protocol networks, network routers 320 in the path between the call participants could send copies of the packets to voice/DTMF monitoring function 316, in addition to sending them to participants. In the alternative, voice/DTMF monitoring function 316 could monitor the network traffic directly, capturing packets sent between the participants to the call, as shown in FIG. 3(C).

In the foregoing descriptions and in the preferred embodiment, the information extracted from the ongoing voice communication is preferably used to make a corresponding entry in an electronic directory. Other actions could be taken as well. For example, if the extracted information is a telephone number, that number could be used to place a call and possibly bridge the called party into the existing ongoing voice communication. In addition, depending upon the nature of the information extracted from the ongoing voice communication, a short message service (SMS) or an e-mail message may be sent to the recognized address extracted from the ongoing voice communication.

When an entry is added to an electronic directory based upon the extracted information, the stored recording of that information could be included into the directory as well. This would allow the user to listen to the recording at some later date, which might be necessary in case of errors in the recognition or directory mapping.

Rather than being triggered to start “listening” for address information, the voice/DTMF monitoring function could be active during the entire duration of the call. If it found directory information, it could then prompt the user, as described above, about what to do with that information. In this case, the information analysis function would have the added task of separating entries because the conversation might involve the exchange of address information for several different entities.

This separation could be based on a variety of factors. For example, it could be based on the timing of the information, with all address information discussed within a limited time window, such as one minute, considered to be part of the same directory entry. In the alternative, separation could be based upon conversation flow, with all information passed within a single exchange considered part of a single directory entry.

The information analysis function could take the uncertainty of how information is divided into directory entries into account during the query and/or resolution phase. If an e-mail address and phone number are found to be two separate results, these two pieces of information would then be divided into two separate directory entities.

The information analysis function could receive information from the telephone switch, which could be leveraged in populating a directory. One example of this information would be the telephone number and possibly the name of the caller and/or called party. In the case of wireless phones, the current location of either the caller or the called party could be provided as well. The caller ID information could be compared to the recognized string for verification purposes. More specifically, the string that was produced by the voice recognition unit is compared to the caller ID information that is retrieved from the switch. A match between the two can be viewed as confirmation that recognized number is correct. If they are similar (e.g., match in 6 out of 7 digits), verification with user may be undertaken. If they are very different, then one may assume that the number being provided is not related to caller ID, so it offers no help in verification.

Caller and/or called ID information could also be recorded with the directory entry to indicate the source of the information newly added to that directory.

Location information could be used as a means of cross-referencing. For example, if the user is providing a number associated with his or her current location (such as “I'm at the hotel now. The number here is . . . ”), then the location could be used as a means to verify that telephone number by using, for example, search features of online content to locate nearby hotels.

For example, a query may be made to a location-based service, such as offered in Google Maps, to find hotels or other business in the area of the speaker's current geographic location, as reported from the cellular location system. If the telephone number that results from speech recognition matches the telephone number reported from the Google (or similar) search for a hotel in that area, then the number can be considered verified. If the number is very different than all the numbers returned as being near the speaker's current location, then this method offers no verification. If the numbers are similar (e.g., matching in 9 of 10 digits), this might indicate an error in speech recognition that could be verified with the user.

Note that this verification with the user could take place off line, by storing both the recognized number and the location-generated number and prompting the user to choose (or try them at some later time), or if could be done in near real time, interrupting the telephone conversation with a signal to the user (e.g., such as the type of signaling used for to alert the user for call waiting), then when the user responds providing the two options via synthesized speech. This response could be provided just to the user or to all parties in the call to simplify the verification by allowing the person who provided the number to choose among the options.

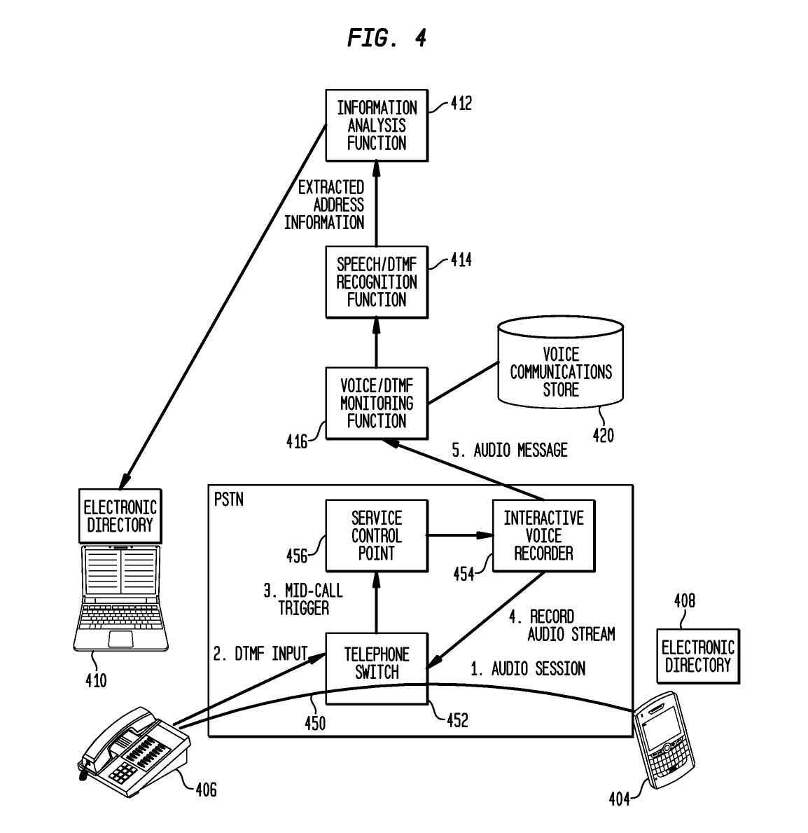

FIG. 4 illustrates an embodiment of the present invention in which the ongoing communication is conducted over a public switched telephone network (PSTN) 450. PSTN 450 includes telephone switch 452, interactive voice recorder (IVR) 454, and service control point (SCP) 456. In this instance, a called party and a calling party established voice connection by dialing a number in the usual manner.

SCP 456 registers with telephone switch 452 its interest in getting notified of any DTMF input provided during the session. In this embodiment, during the session, when a subscriber of the directory update service of the present invention wants to get an address or phone number, that subscriber presses certain predefined keys on the touchtone keypad (for example, “##”). The DTMF input results in a mid-call trigger (for example, O_DTFM_ENTERED event) from the telephone switch 452, which is sent to the SCP 456.

SCP 456 instructs IVR 454 to record the audio stream. IVR 454 interfaces with telephone switch 452 to record the audio message that contains the address or phone number. IVR 454 passes the recorded audio message to voice/DTMF monitoring function 416, which stores the stream in voice communications store 420 and invokes speech/DTMF recognition function 414 and information analysis function 412, as discussed above.

The present invention may also take the form of a method for automatic extraction of information from ongoing voice communications, comprising the steps of: receiving at an electronic processor a signal indicating that a portion of an ongoing communication is to be recorded; recording the portion of the ongoing communication in response to that signal; analyzing the portion of said recorded communication to identify a telephone number; causing the telephone number to be called; and causing the resultant connection to be coupled into the ongoing communication.

This feature may thus be used to add a party to a conference call, by having one participant say something like “System, bridge 732-555-1234 into the call” and having the system trigger on the key phrase (“system bridge”) then extracting the number from the speech that follows, then calling the recognized number. Note that this same method could be used for calling a party separately, without bridging them into the current call by using the bridge number and the pin for the conference bridge.

Another alternative is to have the person providing a telephone number enter the information via touch tone/DTMF. The person receiving this information may then trigger the system to capture information and then tell the person providing information to key phone number in using touch tone key pad. The system then captures this information using the voice/touch tone monitoring function and submits it to the directory.

As should be recognized from the foregoing, the present invention includes not only a method for automatic extraction of information from ongoing voice communications, but also a related system and computer-readable storage media capable of that extraction.

The foregoing description has been presented for purposes of illustration. It is not exhaustive and does not limit the invention to the precise forms or embodiments disclosed. Modifications and adaptations of the invention can be made from consideration of the specification and practice of the disclosed embodiments of the invention. For example, one or more steps of methods described above may be performed in a different order or concurrently and still achieve desirable results.

Other embodiments of the invention will be apparent to those skilled in the art from consideration of the specification and practice of the invention disclosed herein. It is intended that the specification and examples be considered as exemplary only, with a true scope of the invention being indicated by the following claims.

What is claimed is:

1. A method for automatic extraction of information from ongoing voice communications, comprising the steps of:
receiving at an electronic processor a signal indicating that a portion of an ongoing communication is to be recorded;
recording said portion of said ongoing communication in response to said signal;
analyzing said portion of said recorded communication to identify information suitable for storage in an address directory of a participant of said communication maintained in an electronic storage medium; and
sending said identified information to said address directory.

2. The method of claim 1, further including the step of generating said signal indicating that said portion of said ongoing communication is to be recorded, said signal comprising at least one of a touch tone signal and a phrase that is identifiable by a voice/DTMF monitoring function.

3. The method of claim 2, further including the step of generating said signal indicating that said portion of said ongoing communication is to be recorded by manual intervention of a participant in said ongoing communication.

4. The method of claim 2, further including the step of generating said signal indicating that said portion of said ongoing communication is to be recorded by automatic determination that information suitable for storage in an address directory is likely to follow.

5. The method of claim 1, wherein said step of recording lasts for a predetermined time period.

6. The method of claim 1, wherein said step of recording lasts for a time period until said processor is instructed by a participant of said ongoing communication to stop.

7. The method of claim 1, wherein said step of recording lasts for a time period until detection of information suitable for storage in said address directory.

8. The method of claim 1, wherein said step of recording lasts for a time period until a pause in said ongoing communication is detected after detection of information suitable for storage in said address directory.

9. The method of claim 1, wherein said step of recording lasts until a pause in said ongoing communication is detected.

10. The method of claim 1, wherein said step of recording lasts until detection of a change in speaker in said ongoing communication.

11. The method of claim 1, wherein said step of analyzing includes identifying likely telephone numbers.

12. The method of claim 1, wherein said step of analyzing includes identifying likely e-mail addresses.

13. The method of claim 1, wherein said step of analyzing includes identifying likely first name and last name combinations.

14. The method of claim 1, wherein said step of analyzing includes identifying likely postal address information, such as house number, street name, city and/or state.

15. The method of claim 1, wherein said step of analyzing includes initiating interactive communications with a participant in said ongoing communication.

16. The method of claim 1, wherein said step of analyzing is conducted during said ongoing communication.

17. The method of claim 1, wherein said step of analyzing is conducted after termination of said ongoing communication.

18. The method of clam 1, wherein said identified information is stored in said address directory.

19. The method of clam 1, wherein said identified information is used to update said address directory.

20. The method of clam 1, wherein said recorded portion is stored in said address directory.

21. A method for automatic extraction of information from ongoing voice communications, comprising the steps of:
receiving at an electronic processor a signal indicating that a portion of an ongoing communication is to be recorded;
recording said portion of said ongoing communication in response to said signal;
analyzing said portion of said recorded communication to identify a telephone number;
causing said telephone number to be called; and
causing the resultant connection to be coupled into said ongoing communication.

22. The method of claim 21, further including the step of sending said telephone number to an address directory of a participant of said ongoing communication maintained in an electronic storage medium for storage therein.

23. A system for automatic extraction of information from ongoing voice communications, the system comprising:
an electronic processor connected to a communication system, said processor programmed to:
recognize a signal indicating that a portion of an ongoing communication is to be recorded;
record said portion of said ongoing communication in response to said signal;
analyze said portion of said recorded communication to identify information suitable for storage in an address directory of a participant of said ongoing communication maintained in an electronic storage medium; and
send said identified information to said address directory.

24. A computer-readable storage medium comprising instructions that, when executed in a system, causes the system to perform a method of automatic extraction of information from ongoing voice communications, the method comprising the steps of:
receiving at an electronic processor a signal indicating that a portion of an ongoing communication is to be recorded;
recording said portion of said ongoing communication in response to said signal;
analyzing said portion of said recorded communication to identify information suitable for storage in an address directory of a participant of said ongoing communication maintained in an electronic storage medium; and
sending said identified information to said address directory.
